(19) United States
(12) Patent Application Publication
(10) Pub. No.: US 2013/0305668 A1
(43) Pub. Date: Nov. 21, 2013

(54) Debris Intrusion Shield for Jet Engine Applications

(71) Applicants: Stephen Douglas Nichols, Phoenix, AZ (US); Susan Gail Nichols, Phoenix, AZ (US)

(72) Inventors: Stephen Douglas Nichols, Phoenix, AZ (US); Susan Gail Nichols, Phoenix, AZ (US)

(73) Assignee: Stephen Douglas Nichols, Phoenix, AZ (US)

(21) Appl. No.: 13/475,079

(22) Filed: May 18, 2012

(51) Int. Cl. F02C 7/04

(52) U.S. Cl. 55/306

(57) ABSTRACT

The Debris Intrusion Shield for Jet Engine Applications is a prolate hemispheroid metallic assembly installed at the intake of a jet engine. The assembly is designed and intended to limit or prevent the intrusion of solid or semi-solid objects into the engine intake while on the ground or in-flight. All elements of the assembly are arrayed symmetrically about the longitudinal axis of the engine. The assembly is constructed of four basic parts. Tubing is positioned as a radial array about the engine circumference, and serves as the primary debris deflection element. The engine mounting collar serves as the aft point-of-attachment of the assembly to the engine nacelle, and as the aft mounting point for the radial array of tubing. The forward mounting fixture serves as the forward point of connection for the tubing elements. The forward mounting fixture cover serves as a protective cover for the electrical anti-icing elements located at the forward surface of the forward mounting fixture.

### CROSS-REFERENCE TO RELATED APPLICATIONS

Not Applicable.

### STATEMENT REGARDING FEDERALLY SPONSORED RESEARCH OR DEVELOPMENT

Application for Federal sponsorship for building and testing a prototype will be undertaken after submittal of patent application.

### REFERENCE TO SEQUENCE LISTING, A TABLE, OR A COMPUTER PROGRAM LISTING COMPACT DISC APPENDIX.

Not Applicable.

### BACKGROUND OF THE INVENTION

The invention has been developed in the interest of improving the safety of jet engine powered aircraft This application for patent status is of the Non-Provisional Utility type.

Previously patented inventions of a similar design intent known to the authors are;

Rotary Deflector for Aircraft Engine Intakes—U.S. Pat. No. 3,121,545 Nicholas S. Meletiou, Quincy Mass. Dated Feb. 18,1964.

Foreign Body Guards—U.S. Pat. No. 3,426,981 Alastair William Rodney Allcock, Northwood, England. Dated Feb. 11,1969.

Screen Apparatus for Air Inlet—U.S. Pat. No. 3,871,844 Frank F. Calvin, Sr., Chamblee, Ga. Dated Mar. 18,1975.

Protective Screen for Jet-Engine Intake—U.S. Pat. No. 4,149,689 John McDonald, Staten Island, N.Y. Dated Apr. 17,1979.

Intake Ducts for Aircraft Jet Propulsion Plant—U.S. Pat. No. 4,354,346 Michael S. Wooding, Lytham St Annes, England. Dated Oct. 19,1982.

Turbo-Engine Guard—U.S. Pat. No. 4,833,879 Norbertus Verduyn et al, the Netherlands. Dated May 30,1989.

Guard for Jet Engine—U.S. Pat. No. 5,411,224 Raymond M. Dearman, John Bethea, Hattiesburg, Miss. Dated May 2,1995.

Bird Collision Prevention Device For An Aircraft—U.S. Pat. No. 7.971.827 Barrientos. et al. Katy, Tex., Dated Jul. 5, 2011

Specific problems related to the above noted patented designs are not known to the authors of this document It is noted, however, that to the authors' knowledge, none of the inventions noted above have been implemented.

### BRIEF SUMMARY OF THE INVENTION

The invention to be a prolate hemispheroid shaped metallic assembly installed at the intake of a jet engine.

The assembly is designed and intended to limit or prevent the intrusion of solid or semi-solid objects into the engine intake while on the ground or in-flight .

The design criteria of this assembly are predicated on, in order of importance, installed safety, efficacy, impact on aircraft performance, weight, and costs—both initial and on-going costs. Since no previous designs of similar intent have been implemented to date, it is possible or probable these designs did not directly address or meet some or all of the above noted criteria sufficiently for acceptance and/or implementation by related Federal Regulatory agencies or the aircraft industry.

### BRIEF DESCRIPTION OF THE SEVERAL VIEWS OF THE DRAWINGS

Ten drawings are included in this application, including;

FIG. 1—Three dimensional perspective rendition of the assembly installed on a jet engine.

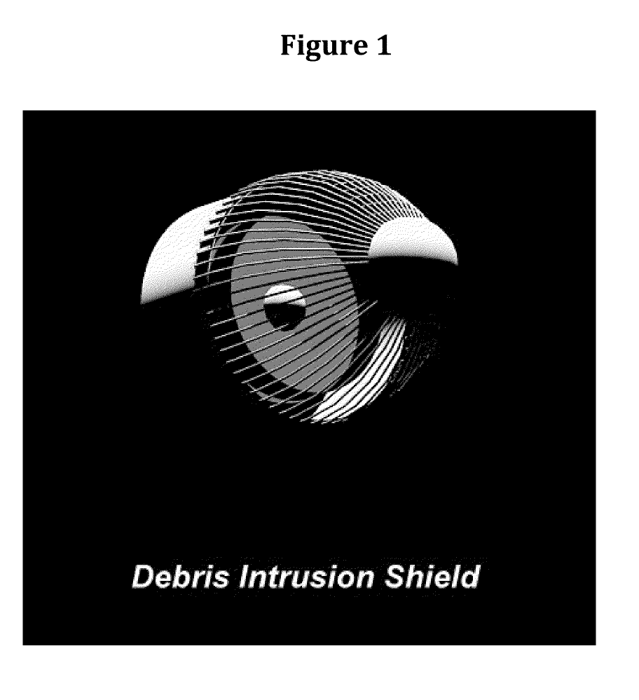

FIG. 2—Tubing Profile Detail—Longitudinal view of the assembly illustrating orientation and relative positions of all elements of the assembly. FIG. includes callouts for related drawings, and specific fabrication notes and dimensions for an eight-foot diameter intake engine example.

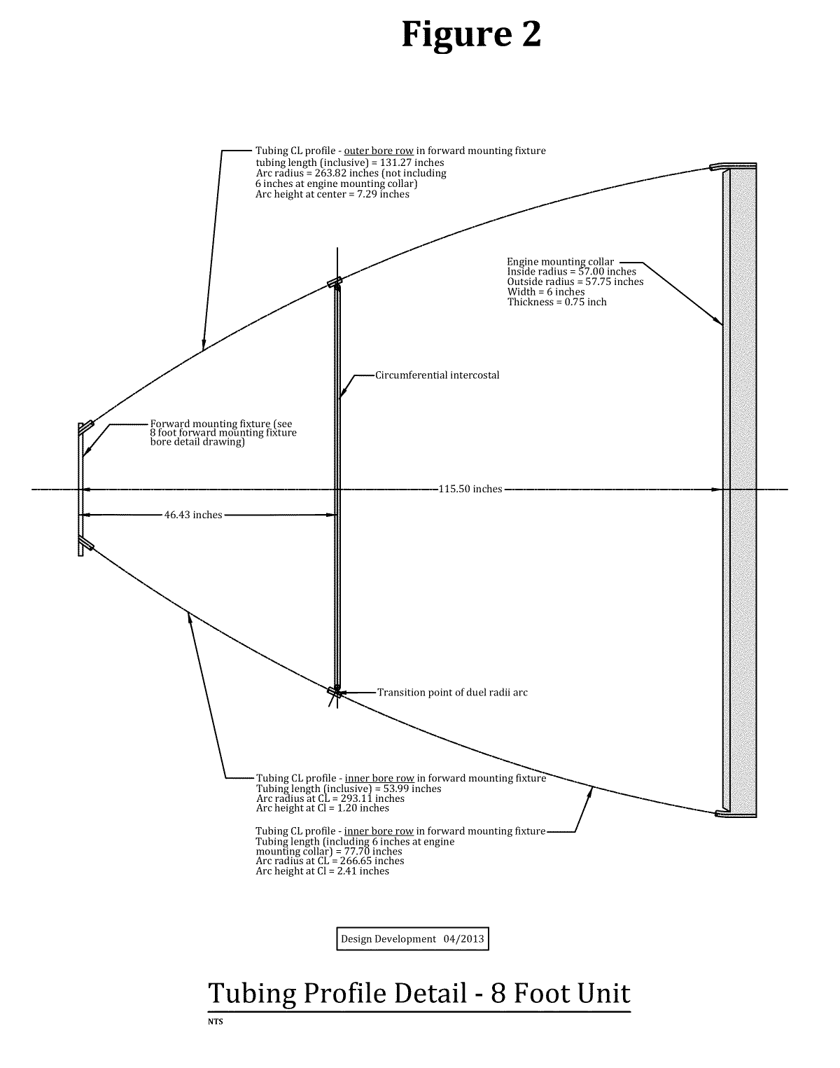

FIG. 3—Forward Mounting Fixture Bore Detail—Plan and section views of mounting fixture bore detail for an eight-foot diameter intake engine example.

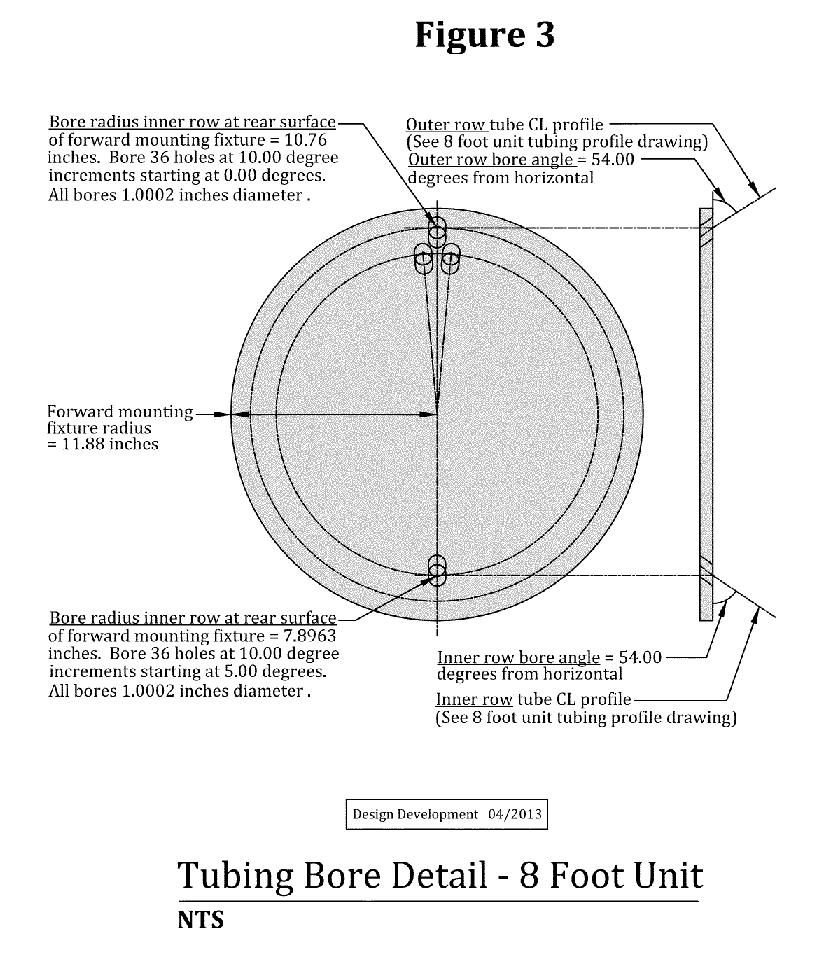

FIG. 4—Anti-icing Wiring Diagram at Forward Mounting Fixture—Plan and section view of power busses, power supply and anti-icing wiring at forward mounting fixture, including routing to tubing elements. Also illustrates relative positions of fixture cover and fixture cover support material.

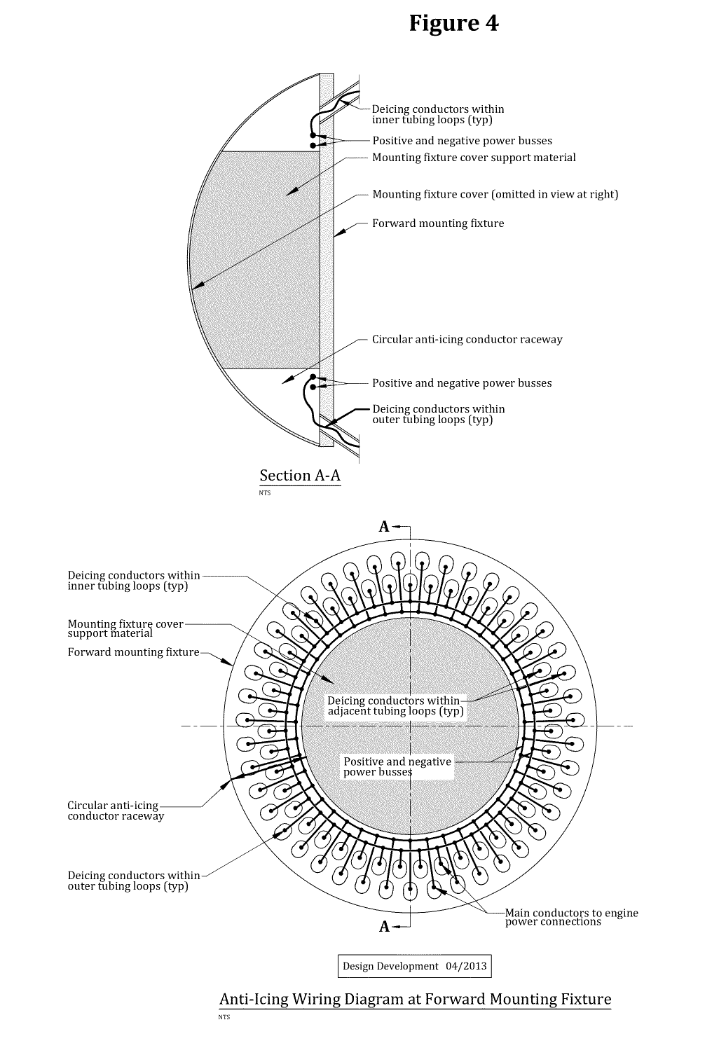

FIG. 5—Debris Shield—Front View—drawing illustrating relative positions of all elements of the assembly as installed on jet engine nacelle. (Forward mounting fixture cover omitted for clarity).

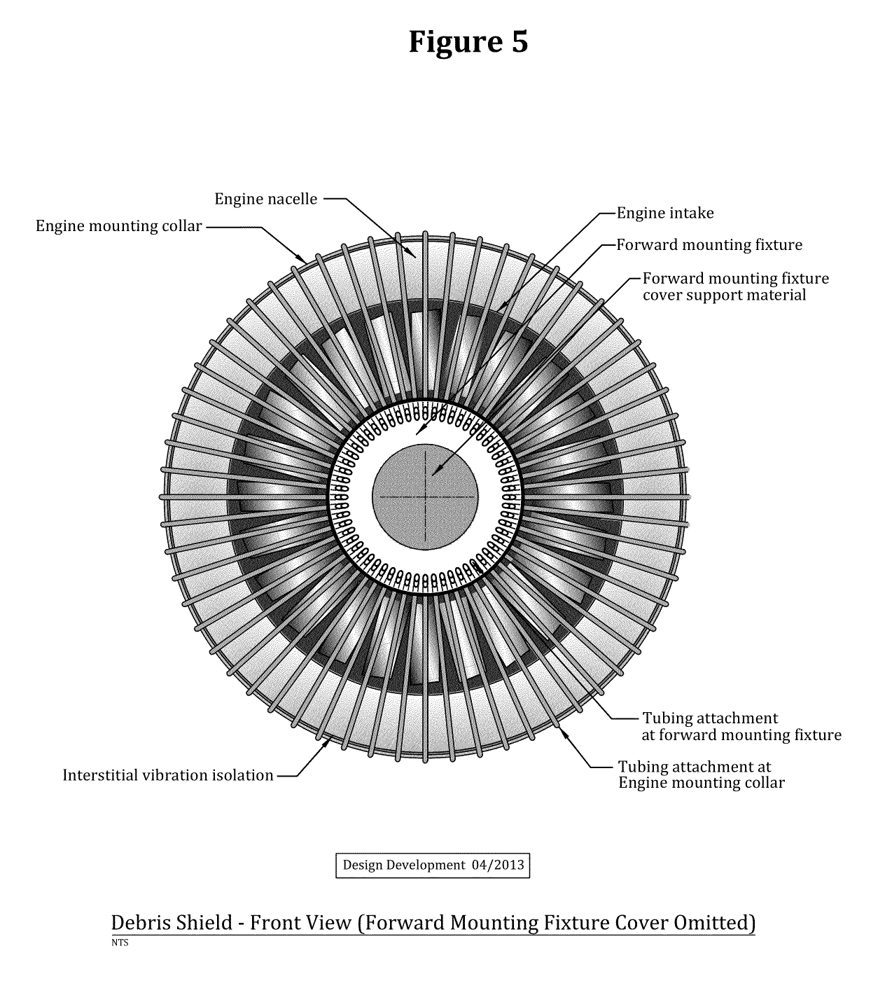

FIG. 6—Forward Mounting Fixture Cover Retainer Clip—Section of forward mounting fixture—fixture cover, gasketing, retainer clip and clip fastener.

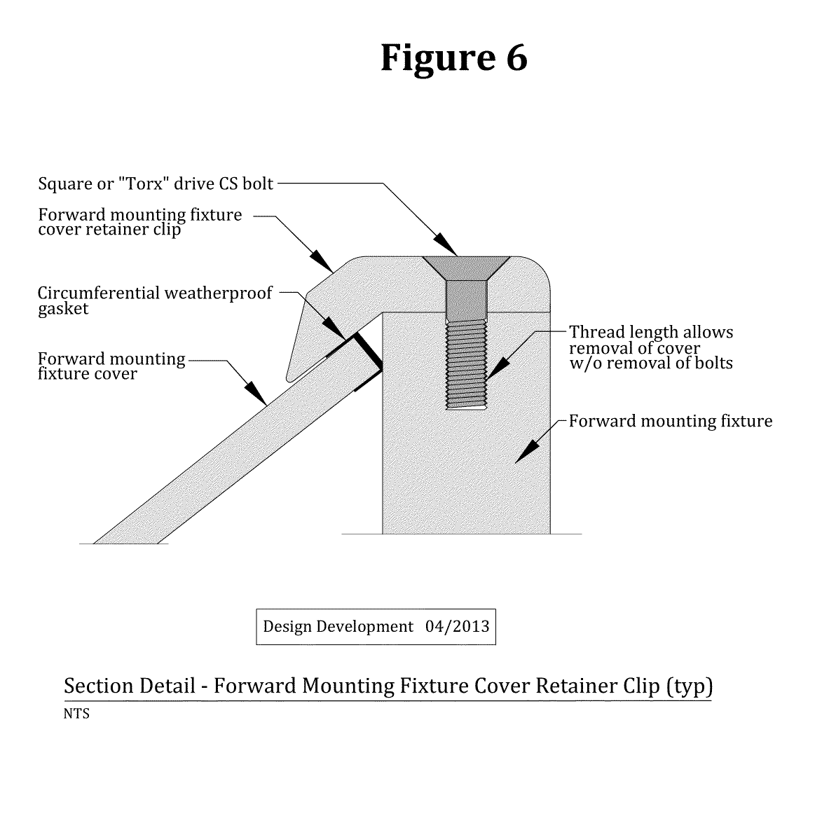

FIG. 7—Engine Mounting Collar Attachment Details—Plan and section views illustrating attachment of engine mounting collar to engine nacelle. Views include relative positions of mounting collar, nacelle, vibration isolation and bolts and relief.

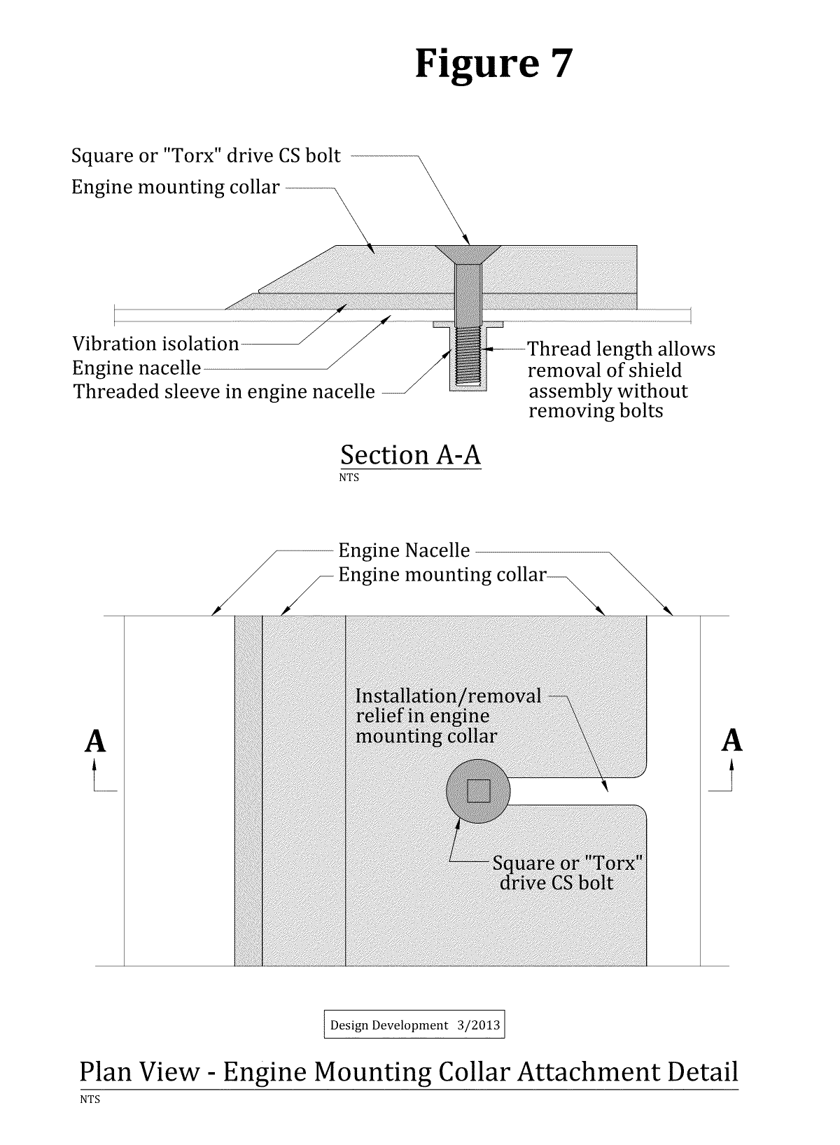

FIG. 8—Anti-Icing Element Access at Engine Mounting Collar—Plan and section views illustrating tubing routing, tubing attachment to mounting collar, anti-icing conductor routing, and method of access to anti-icing conductors at mounting collar.

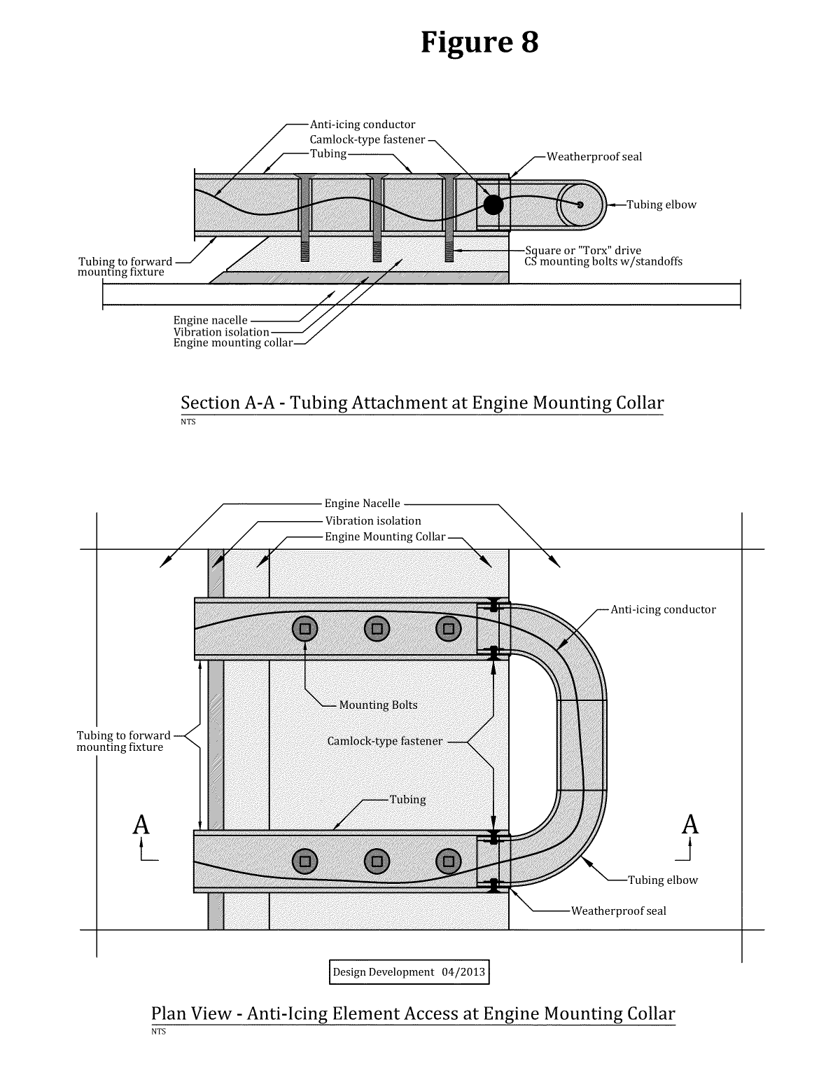

FIG. 9—Anti-Icing Power Routing at Engine Mounting Collar—Plan and section views illustrating routing of anti-icing power supply conductors to connection at engine nacelle. Views include tubing element routing, anti-icing conductor and power supply routing, tubing attachments to engine mounting collar, vibration isolation and tubing sealing components.

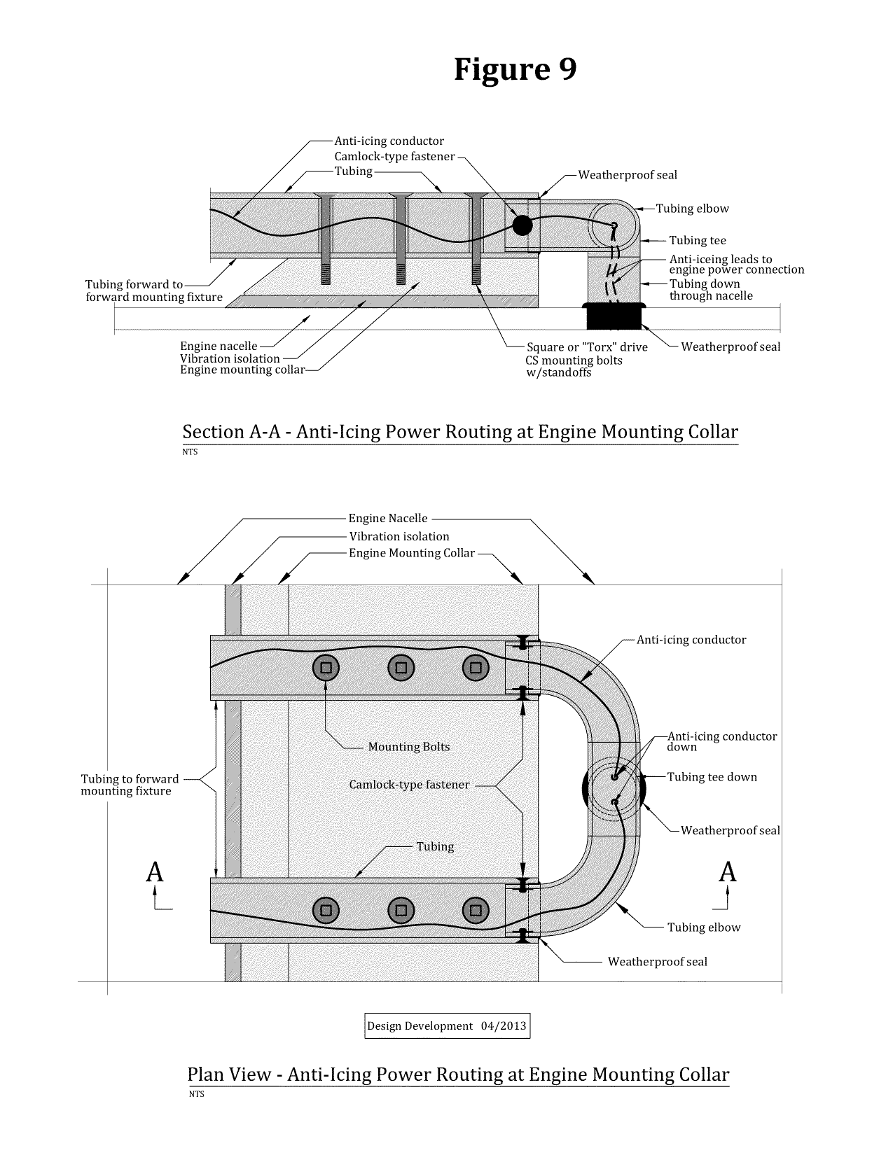

FIG. 10—Tubing/Forward Mounting Fixture Attachment Detail—Section view illustrating securing of tubing elements to forward mounting fixture.

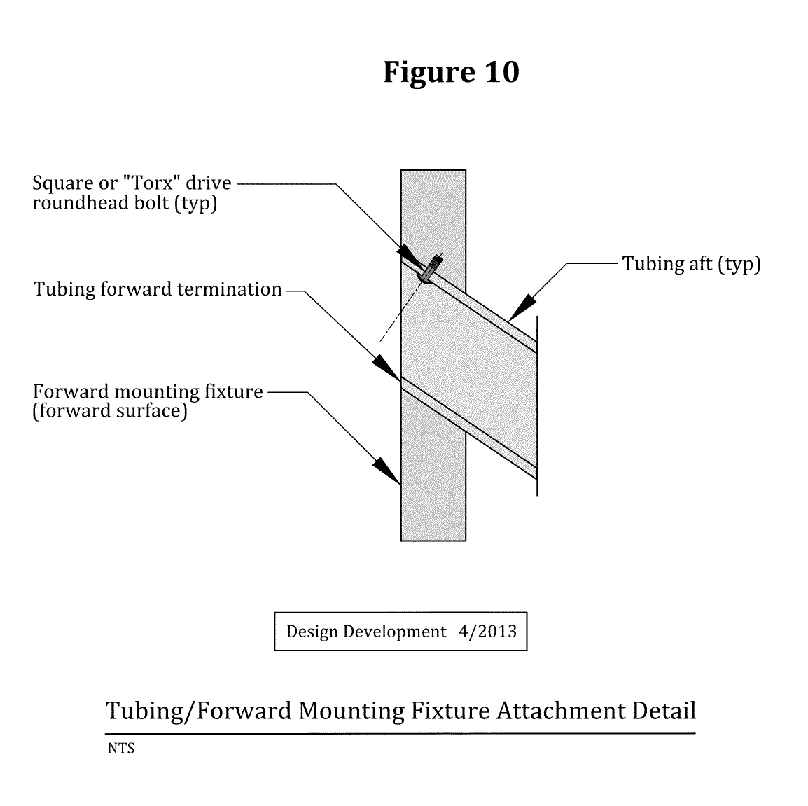

### DETAILED DESCRIPTION OF THE INVENTION

The invention is designed and intended to be permanently mounted at the forward (intake) end of an aircraft jet engine or engine nacelle.

The invention is designed and intended to prevent the intrusion of solid and/or semi-solid matter into the intake of a jet engine.

The assembly is designed to prevent intrusion of proximate large objects while the engine is operating while on the ground, and to deflect matter, encountered while in-flight, away from the engine intake. The matter that is intended to be deflected while in-flight is that of a size and nature that would damage the engine sufficiently to cause a significant reduction in engine performance, or engine failure.

Materials selected for this design are common to the aerospace industry due to their proven weight VS strength, workability, durability and low maintenance requirements. All materials are of the off-the-shelf type in consideration of advantages in availability and cost.

This invention, and the criteria used in its conception and design, appears to differ significantly from those examples we have discovered and listed above in the BACKGROUND OF THE INVENTION. The primary considerations here are the safety of the assembly when installed, the defined functional intent of the assembly, and weight/cost/maintenance factors required for this concept to be seriously considered for implementation. Unit installed safety; efficacy, weight and cost considerations are not expressed in the above examples of similar inventions, but are critical issues in a practical solution to an acknowledged aircraft safety issue—that of in-flight bird strikes. Another critical issue not addressed in previous examples is that of “net free area”. Net free area is defined here as the relative open area within the assembly structure through which air can pass into the engine inlet Any limiting of this area has a significant negative effect on engine performance. This design recognizes “net free area” as a critical consideration that has been addressed in the design calculations.

### Assembly

a. Assembly shall be of the configuration illustrated in the detail drawings.

b. Assembly shall be constructed primarily of aluminum or titanium as noted in these specifications.

c. Four specified parts shall be used in the construction of assembly—tubing elements, forward mounting fixture, forward mounting fixture cover and

b. engine mounting collar. Note that sizes and configuration of the component parts, and number of required tubes, vary with the model of engine and airframe for which the assembly is intended.

### Tubing

a. Tubing shall be seamless titanium or aluminum.

b. Tubing shall be curved as illustrated on the detail drawings. Tubing shall be cut perpendicular to the longitudinal axis at the aft end, flush with the aft edge of the engine mounting collar, and trimmed or ground to a flush fit with the forward surface of the forward mounting fixture. Note that the tubing size, length, radius and number vary with the model of engine and airframe for which the assembly is intended.

c. A circumferential tubing element equal in specification to the longitudinal tubing elements shall be located inside the tubing assembly where the inside diameter of the tubing assembly is equal to the inside diameter of the engine intake. This element shall be welded to each longitudinal tubing element in an orientation perpendicular to the longitudinal axis of the engine.

### Forward Mounting Fixture

a. Forward mounting fixture shall be fabricated from aluminum or titanium plate.

b. Forward mounting fixture shall be of the configuration indicated on the detail drawings. Note that the diameter and other characteristics of the forward mounting fixture vary with the model of engine and airframe for which the assembly is intended.

c. Forward mounting fixture shall be bored in a radial pattern as indicated on the detail drawings. Number of bores, bore centerline and angle of bores varies with the model of engine and airframe for which the assembly is intended. Aft perimeter of bored holes shall be radiused to mitigate shearing of tubing.

### Forward Mounting Fixture Cover

a. Forward mounting fixture cover shall be fabricated from titanium or aluminum sheet.

b. Forward mounting fixture cover shall be of the configuration illustrated in the detail drawings. Note that the diameter and other characteristics of the mounting fixture cover vary with the model of engine and airframe for which the assembly is intended.

Forward mounting fixture cover retention clips shall be fabricated from titanium or aluminum plate. Clips shall be configured and located as indicated in the detail drawings.

d. Forward mounting fixture cover shall be secured to forward mounting fixture as indicated on the drawings.

e. The annular space between the aft surface of the forward mounting fixture cover and the forward surface of the forward mounting fixture shall be partially filled with aircraft specification rigid closed-cell foam as illustrated in the detail drawings. Foam shall be glued to the forward surface of the forward mounting fixture with aircraft specification adhesive.

### Engine Mounting Collar

a. Engine mounting collar shall be fabricated from titanium or aluminum plate.

b. Engine mounting collar shall be of the size and configuration illustrated in the detail drawings. Note that the diameter and mounting characteristics of the mounting collar vary with the model of engine and airframe for which the assembly is designed.

c. Tubing shall be bolted to mounting collar as illustrated in the detail drawings. Aft end of tubing shall be flush with aft edge of mounting collar.

d. Aerospace specification elastomeric vibration-damping material shall be installed as a continuous element, equal in width to the mounting collar, between the mounting collar and the engine nacelle as illustrated in the detail drawings.

e. The mounting collar and vibration-damping element shall be secured to the engine nacelle with bolts. Note that number, size and positioning of mounting bolts will be determined by the manufacturer of the engine and airframe to which the assembly is intended.

f. Engine mounting collar shall be relieved from the centerline of the mounting bolt locations rearward to the aft edge of the mounting collar as shown on the drawings. Relief width shall be nominally wider than mounting bolt diameter so as to facilitate the removal and reinstallation of the assembly on the engine nacelle.

1. A debris intrusion prevention assembly to be attached to the exterior of the forward end of a jet engine nacelle; the assembly including:
a. a metal circumferential engine mounting collar, with interstitial vibration isolation, connected to the engine cowling by means of bolts at installation slots, threaded bolt receptors imbedded in the cowling, providing the aft mounting fixture for;
b. evenly spaced, curved, metal tubing elements arranged circumferentially around the mounting collar, protruding forward forming a prolate hemispheroid assembly along the longitudinal axis of the engine nacelle to;
c. a circular metal plate bulkhead radially drilled to receive the tubing elements at the forward terminal of the assembly; wherein the bulkhead includes a metal cover at the forward surface of the bulkhead for protection of electrical power bus elements mounted at this surface.

2. The debris intrusion prevention assembly of claim 1, further includes:
a. an electrical anti-icing resistance wire element within each tubing element, routed from the electrical power buss elements at the forward surface of the forward mounting fixture, rearward to the engine mounting collar, looping to the adjacent tubing element and continuing forward to reconnect to the electrical power buss elements at the forward surface of the mounting fixture; wherein the electrical buss elements at the forward surface of the mounting fixture are provided power from a single point engine power source connection through conductors routed through a single pair of adjacent tubing elements.
